(19) United States
(12) Patent Application Publication
(10) Pub. No.: US 2016/0199930 A1
(43) Pub. Date: Jul. 14, 2016

(54) COMBINED BRAZE AND COATING METHOD FOR FABRICATION AND REPAIR OF MECHANICAL COMPONENTS

(71) Applicant: Siemens Energy, Inc., Orlando, FL (US)

(72) Inventor: James A. Yarbrough, Spring, TX (US)

(21) Appl. No.: 14/596,250

(22) Filed: Jan. 14, 2015

(51) Int. Cl. B23K 1/00; C22C 30/00; B23K 1/20

(52) U.S. Cl. CPC B23K 1/0018; B23K 1/20; C22C 30/00

(57) ABSTRACT

A method disclosed herein involves disposing (125) a pre-sintered preform (50) onto a machined component surface (44) to form a pre-braze assembly. The pre-braze assembly is then heated (130) in order the melt the preform at a temperature less than a liquidus temperature of the component surface to form a multi-layer component (52) having a protective surface (56). The preform may be formed by sintering a first powder including a protective alloy and a second powder including a composition of the protective alloy that is supplemented with an additional element such that a solidus temperature of the second powder is lower than a solidus temperature of the first powder. The method allows a service run gas turbine ring segment (30) to be repaired without chemical stripping or welding.

### FIELD OF THE INVENTION

This application relates to materials technology in general and more specifically to methods for fabricating and repairing mechanical components in which a protective coating is applied by brazing a pre-sintered preform onto a metallic substrate.

### BACKGROUND OF THE INVENTION

Modern gas turbine engines include a compressor for compressing air, a combustor for mixing the compressed air with fuel and igniting the mixture, and a turbine blade assembly for producing power. FIG. 1 illustrates a non-limiting example of a known gas turbine engine 2 having a compressor section 4, a combustor section 6 and a turbine section 8. In the turbine section 8 there are alternating rows of stationary airfoils 18 (commonly referred to as “vanes”) and rotating airfoils 16 (commonly referred to as “blades”). Each row of blades 16 is formed by a circular array of airfoils connected to an attachment disc 14 disposed on a rotor 10 having a rotor axis 12. The blades 16 extend radially outward from the rotor 10 and terminate in blades tips. The vanes 18 extend radially inward from an inner surface of vane carriers 22, 24 which are attached to an outer casing 26 of the engine 2.

Between the rows of vanes 18 a ring seal 20 is attached to the inner surface of the vane carrier 22. The ring seal 20 is a stationary component that acts as a hot gas path guide between the rows of vanes 18 at the locations of the rotating blades 16. The ring seal 20 is commonly formed by a plurality of ring segments 30, 52 (see FIGS. 2 and 4) that are attached either directly to the vane carriers 22, 24 or indirectly such as by attachment to metal isolation rings (not shown) attached to the vane carriers 22, 24.

During engine operation, high-temperature/high-velocity gases 28 flow primarily axially with respect to the rotor axis 12 through the rows of vanes 18 and blades 16 in the turbine section 8. The ring seals 20 are exposed to these gases. Because the combustor section 6 can operate at temperatures exceeding 2,500° F., the turbine blades 16 and ring seals 20 must be made of materials capable of withstanding these temperatures. Moreover, ring seals 20 are commonly formed by a plurality of abradable ring segments 30, 52 that improve performance and/or efficiency of the gas turbine engine 2 by sealing the gap between the stationary ring segments 30, 52 and the rotating blades 16, or by keeping such a gap as small as possible.

FIG. 2 illustrates one example of a worn ring segment 30 constructed of a ring segment base 32 having an abradable protective coating 34 bonded to an inner surface of the ring segment base 32 to form a sealing surface 36. Over time during operation of a gas turbine engine 2 containing a ring seal 20, at least a portion of the sealing surface 36 may be worn to form an abraded or otherwise damaged portion 38. Ring segment bases 32 are commonly made of high temperature superalloys based on nickel, cobalt, or nickel-iron that maintain mechanical strength, creep resistance, surface stability, and corrosion/oxidation resistance at high temperatures. In other cases the ring segment bases 32 may be constructed of non-superalloy materials such as stainless steels.

The sealing surface 36 of each ring segment 30, 52 is typically coated with an oxidation resistant metallic bond coat (often an MCrAIY alloy) and a thermally insulating ceramic thermal barrier coating (TBC). Such a combination of bond coat and thermal barrier coating is often referred to as a thermal barrier coating system. In other cases the sealing surface 36 may only include metal alloys such as MCrAIY alloys. Sometimes such metallic sealing surfaces are in the form of abradable sealing surfaces having a honeycomb structure that is bonded to the ring segment base 32. Whether ceramic and/or metallic in nature, such abradable sealing surfaces 36 are generally designed to wear away in a controlled fashion that ultimately requires repair or replacement of the ring segments 30, 52 to maintain safe and efficient operation of the gas turbine engine.

Repair of worn ring segments 30 is typically carried out by first removing the abradable sealing surface 36 using a chemical stripping process. Following the chemical removal of the sealing surface 36, any damage to the ring segment base 32 may then be blended out using a variety of different mechanical techniques involving removal of metallic portions of the ring segment base 32. Such removal of material is generally offset using weld buildup techniques to deposit additional (replacement) metal onto the inner surface of the ring segment base 32. After weld buildup, additional blending and straightening may then be carried out using mechanical and thermal techniques known the relevant art to produce refurbished ring segments. A replacement coating is then applied, such as by a thermal spray technique.

### BRIEF DESCRIPTION OF THE DRAWINGS

The invention is explained in the following description in view of the drawings that show:

FIG. 1 illustrates a non-limiting example of a gas turbine engine;

FIG. 2 illustrates a non-limiting example of a worn ring segment of a gas turbine engine;

FIG. 3 is a schematic diagram of one embodiment of a process for fabricating or repairing a component containing a protective coating bonded to a metallic base;

FIG. 4 illustrates one embodiment of a process for repairing a worn or damaged ring segment of a gas turbine engine; and

FIG. 5 is a cross-sectional image of the protective coating and a portion of the metallic base of a ring segment repaired using one embodiment.

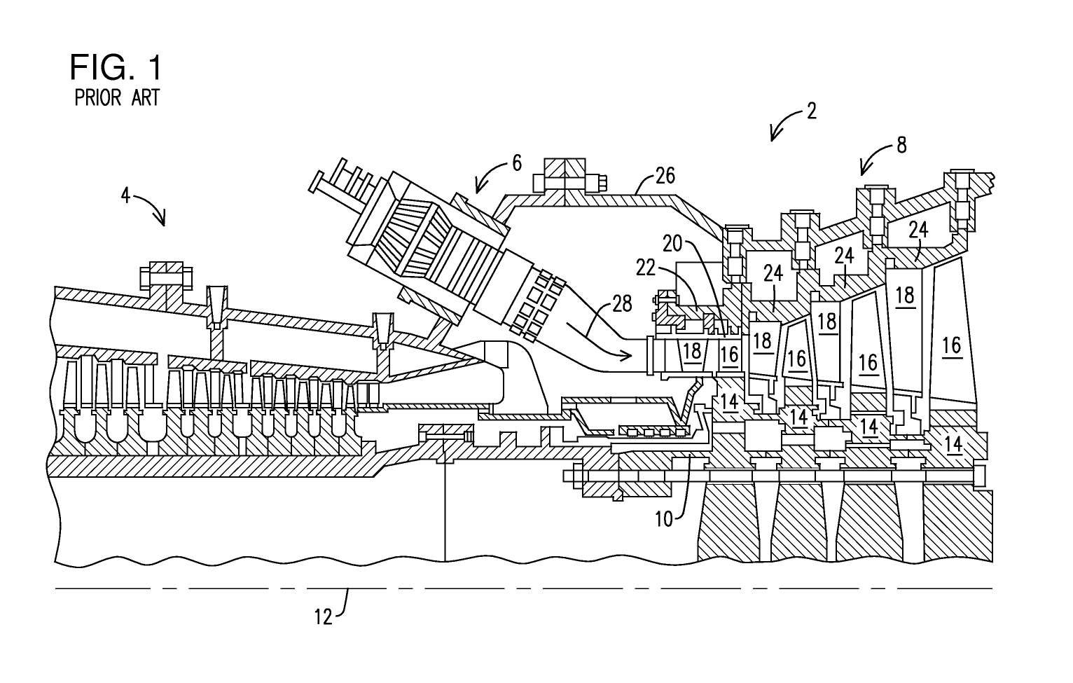

### DETAILED DESCRIPTION OF THE INVENTION

The present inventor realized that a need exists to discover alternative methods and materials enabling the fabrication and repair of ring segments, and other components subjected to high-temperature/high-velocity conditions, without the need to perform chemical stripping and/or weld buildup techniques that may impart mechanical and chemical defects or incongruities to the resulting components. Although various techniques are known to eliminate or mitigate the harmful effects of chemical stripping and weld buildup techniques, the inventor discovered a repair/fabrication process that can improve the rate of success and reduce costs by preventing mechanical and chemical defects altogether. The present inventor discovered that the harmful effects and costs of chemical stripping and weld buildup may be avoided by employing a novel coating process in which a pre-sintered preform (PSP) exhibiting thermally-protective properties can be directly brazed onto a component surface to produce a protective coating having excellent bonding characteristics.

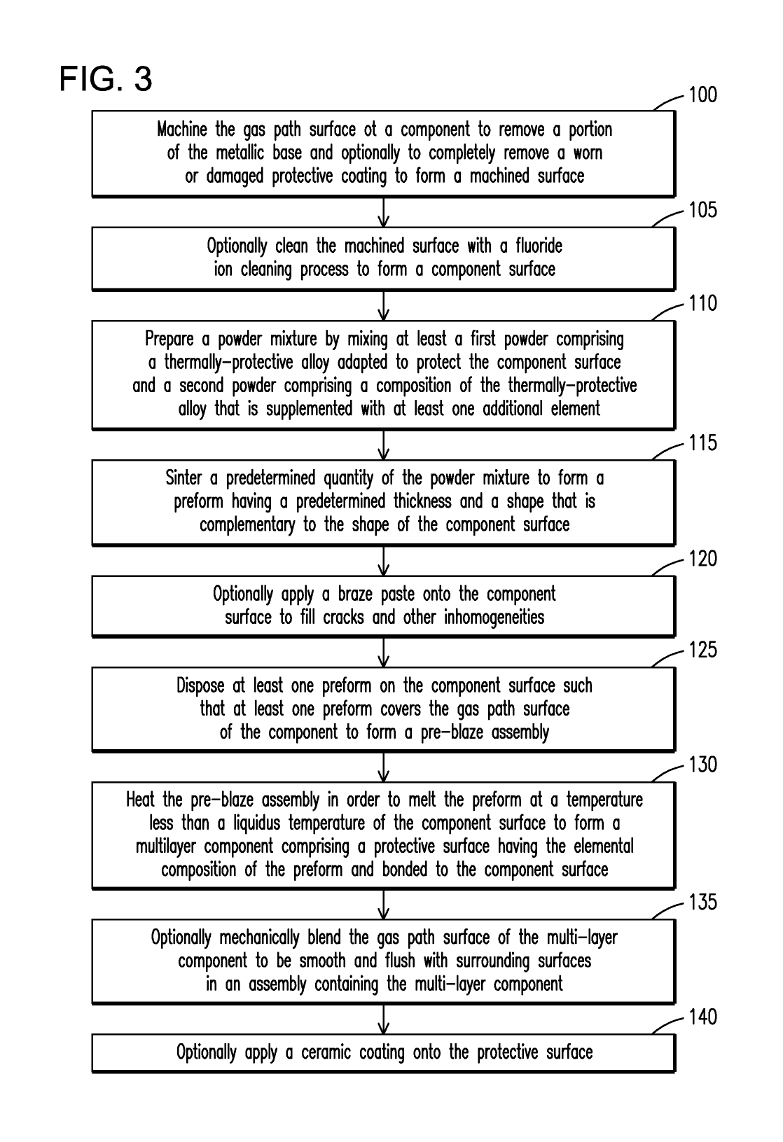

FIG. 3 illustrates non-limiting process steps for fabricating or repairing a component containing a protective coating 34 bonded to a metallic base 32.

Step 100 involves machining the gas path surface of a component, such as a gas turbine ring segment, to remove a portion of the metallic base 32, and optionally to completely remove a worn or damaged protective coating 34, to form a repair surface. The machining may include any mechanical (non-chemical) process known in the relevant art to remove metallic and/or ceramic materials from a metallic base substrate. Non-limiting examples of machining processes include grinding processes including CNC grinding techniques known in the relevant art, as well as known processes for mechanically blending machined surfaces to remove raised areas and/or loose materials. Blending and cleaning techniques known in the art may be used to ensure that the resulting machined surface is uniformly shaped (e.g., flat, arcuate, convex, concave, etc.) and free from production contamination. The non-gas path sides of the machined surface (e.g., back side, circumferential ends, forward and aft faces) may optionally be grit blasted to provide clean secondary surfaces, with care taken to avoid grit blasting of the gas path surface.

Use of machining (grinding) in lieu of chemical techniques to remove a worn or damaged protective coating 34 avoids the incongruities and defects that often accompany chemical removal processes already known in the relevant art. Unlike chemical techniques, the machining step 100 can completely remove a worn or damaged protective coating 34 while minimizing an amount of the metallic base 32 that is removed. The machining step 100 can provide a machined surface free of surface incongruities and defects that are generally unavoidable when using prior art chemical cleaning/weld buildup techniques.

In optional step 105 the machined surface may be cleaned with a fluoride ion cleaning (FIC) process to from a component surface suitable for subsequent brazing. In some embodiments the FIC process may involve cleaning with hydrogen fluoride gas. Use of FIC cleaning advantageously removes unwanted oxides and residual coating remnants (e.g., diffusion coating remnants) from the machined surface and within microscopic and macroscopic cracks present on the machined surface. In other embodiments, cleaning of the machined surface may be carried out using vacuum cleaning, hydrogen cleaning, or a combination of vacuum cleaning, hydrogen cleaning and/or fluoride ion cleaning, depending upon on the material characteristics of the metallic base.

FIC processes of the optional step 105 may involve vacuum/thermal/chemical processing steps occurring at a pressure and temperature range of 100 torr (133 mbar) to atmospheric pressure and 1750° F. to 1900° F. (955 to 1040° C.) using HF (anhydrous hydrogen fluoride) gas which can be precisely metered during the FIC process. The FIC process can eliminate deeply imbedded oxides (e.g., aluminum and titanium oxides) at the surface and within cracks through the following reactions:

6HF+Al₂O₃→2AlF₃+3H₂O

4HF+TiO₂→TiF₄+2H₂O

6HF+Cr₂O₃→2CrF₂+F₂+3H₂O

Use of vacuum or partial pressures may increase the effectiveness of oxide removal from cracks by forcing HF gas into cracks and by increasing volatilization of oxide products under vacuum conditions. Removal of some amounts of metallic Al and Ti through volatilization may also occur via the following reactions:

6HF+2Al→2AlF₃+3H₂

8HF+2Ti→2TiF₄+4H₂

The rate of cleaning in FIC is a function of the temperature, concentration of HF, and alloy composition.

Steps 110 and 115 involve preparation of a pre-sintered preform (PSP) that is adapted to be directly brazed onto the machined surface to produce a protective coating. Step 110 involves preparing a powder mixture by mixing at least a first powder and a second power in a predetermined ratio. The first powder comprises a thermally-protective alloy adapted to complement (e.g., bond to) and protect the component surface under extreme thermal environments involving high-velocity gases. The second powder comprises a similar composition to that of the first powder except that the second powder contains at least one additional element that alters the solidus temperature of the second powder relative to a solidus temperature of the first powder. Thus, the second powder can serve as a braze material capable of bonding the composition of the first powder to the machined surface to produce a protective coating.

The term “solidus temperature” is used herein in a general sense to describe a temperature (or a locus of temperatures on a phase diagram) below which a given substance is completely solid (crystallized).

The composition of the first and second powders may depend upon the material properties of the machined surface to be coated. For superalloy substrates based on nickel, cobalt or nickel-iron superalloys, the first powder may contain a thermally-protective alloy comprising Co, Ni, Cr, Al and Y; whereas the corresponding second powder may contain an alloy comprising Co, Ni, Cr, Al, Y and at least one additional element such as Si, B, or a mixture thereof, which lowers the solidus temperature of the second powder relative to that of the first powder. In some embodiments a composition of the first powder comprises Co, Cr, Ni, W, Ta, C, Zr and Ti; whereas a composition of the corresponding second powder comprises Co, Cr, Ni, W, Ta, C, Zr, Ti and B.

In one non-limiting embodiment, for example, a composition of the first powder includes 54 wt % of Co, 23.5 wt % of Cr, 10 wt % of Ni, 7 wt % of W, 3.5 wt % of Ta, 0.6 wt % of C, 0.5 wt % of Zr, 0.2 wt % of Ti and unavoidable impurities (based on a total weight of the first powder); whereas a composition of the corresponding second powder comprises 47 wt % of Co, 28.3 wt % of Cr, 10 wt % of Ni, 7 wt % of W, 3.5 wt % of Ta, 0.6 wt % of C, 0.5 wt % of Zr, 0.2 wt % of Ti, 2.8 wt % of B, and unavoidable impurities (based on a total weight of the second powder). The first powder in this example is commercially available under the trade name MAR-M-509™ (CO222); whereas the second powder in this example is commercially available under the trade name MAR-M-509B™ (CO333).

In other embodiments, the preform may be formed of a blended powder mixture having an elemental composition within the following ranges:

Ni: 30-40 wt %;

Cr: 20-25 wt %;

Al: 2-10 wt %;

Si: 1-8 wt %;

W: 0.1-2.0 wt %;

Ta: 0.1-2.0 wt %;

B: 0.1-1.0 wt %;

Y: 0.1-1.0 wt %;

unavoidable impurities; and balance

Co,

based on a total weight of the powder mixture.

In one particular embodiment, the elemental composition of the preform is approximately:

Ni: 32.5 wt %;

Cr: 22.5 wt %;

Al 5.3 wt %;

Si 4.5 wt %;

W 0.65 wt %;

Ta: 0.3 wt %;

B: 0.3 wt %;

Y: 0.23 wt %;

unavoidable impurities; and

Co

based on a total weight of the powder mixture.

For preforms made from two powders, a ratio of the first powder to the second powder in the powder mixture ranges from about 25/75 by weight to about 75/25 by weight. In some embodiments the ratio of the first powder to the second powder in the powder mixture is about 50/50 by weight. A powder size of the first and second powders ranges from a mesh of about 10 (2000 microns) to about 1250 (10 microns). In some embodiments the powder sizes of the first and second powders ranges from about −120 to +325 mesh. In some embodiments the powder mixture is bound together into a paste using a liquid binder, in which case a proportion of the liquid binder ranges from about 5% by volume to about 15% by volume.

Step 115 involves sintering a predetermined quantity of the powder mixture to form a PSP having a predetermined thickness and a shape that is complementary to the shape of the component surface to provide surface-to-surface contact when placed together. The predetermined thickness of the PSP is controlled to obtain a protective surface having a required thickness to adequately protect the surface of the component. The shape of the PSP is determined by the shape of a mold in which the sintering step 115 occurs. Following the sintering step 115, the resulting PSP may be further shaped by, for example, cutting in order to dictate the ultimate shape and size of the protective surface that is formed in the brazing step 130.

Use of the PSP—as opposed to applying the powder mixture directly to the component surface—advantageously allows precise placement and bonding (using, for example, resistance tack welding) of the PSP to the component surface to ensure adequate placement and bonding of the resulting protective surface to the underlying surface. Use of the PSP also provides improved control over the thickness of the resulting protective surface because, for example, shrinkage that naturally occurs during heat processing of powders is confined to the sintering step 115—as opposed to occurring during the brazing step 130.

Optional step 120 involves applying a braze paste onto the component surface to fill cracks and other inhomogeneities that may be present on the component surface in some embodiments. The braze paste may comprise, for example, a powder mixture in a paste form being bound together using a liquid binder as described above. Use of the optional braze paste may be beneficial in certain embodiments wherein pre-processing of the component surface results in cracks, grooves, or other inhomogeneities which may affect contact and bonding of the PSP to the component surface.

In Step 125 at least one PSP is disposed onto the component surface such that at least one PSP covers the prepared gas path surface of the component to form a pre-braze assembly. In some embodiments a plurality of PSPs may be layered upon one another to produce a thicker protective layer or a graded protective layer in which the composition of the protective layer is varied along the thickness of the protective layer. In some embodiments a plurality of PSPs may be layered upon one another such that a surface area of the PSPs may be altered relative to one another. By non-limiting example, the Step 125 may involve disposing a first PSP that exactly covers the component surface and a second PSP on top of the first PSP, wherein the second PSP has a larger surface area than the first PSP and is positioned to overhang each edge of the component surface. In other embodiments a single PSP may be disposed onto the component surface wherein the single PSP may partially or fully cover the component surface or may overhang at least one boundary (edge) of the component surface.

In step 130 the pre-braze assembly is heated in order to melt (braze) the at least one PSP at a temperature less than a liquidus temperature of the component surface to form a multi-layer component comprising a protective surface having the elemental composition of at least one PSP and bonded to the component surface. In some embodiments the heating step 130 may occur in a furnace under either vacuum conditions or under an inert gas atmosphere. Heating conditions (e.g., temperature, pressure, time) are adjusted such that the resulting protective surface satisfies certain requirements in terms of porosity, inclusions and diffusion. For example, in some embodiments the heating conditions are adjusted such that a porosity of the protective surface does not exceed 4% by volume, the maximum pore size does not exceed 0.015 inch, the maximum number of inclusions per square centimeter (cm²) does not exceed 1, a maximum size of inclusions does not exceed 100 μm, and/or the braze coating must show at least 90% diffusion and bonding with the base metal.

The term “liquidus temperature” is used herein in a general sense to describe a temperature above which a material is completely liquid and the maximum temperature at which crystals can co-exist within the melt in thermodynamic equilibrium.

Optional step 135 involves applying a ceramic coating onto the protective surface to form an outer thermal barrier coating (TBC). In some embodiments the ceramic coating comprises a yttria-stabilized zirconia (YSZ).

Step 140 involves mechanically blending the gas path surface of the multi-layer component to be smooth and flush with surrounding surfaces in an assembly containing the multi-layer component, such as ring seal 20.

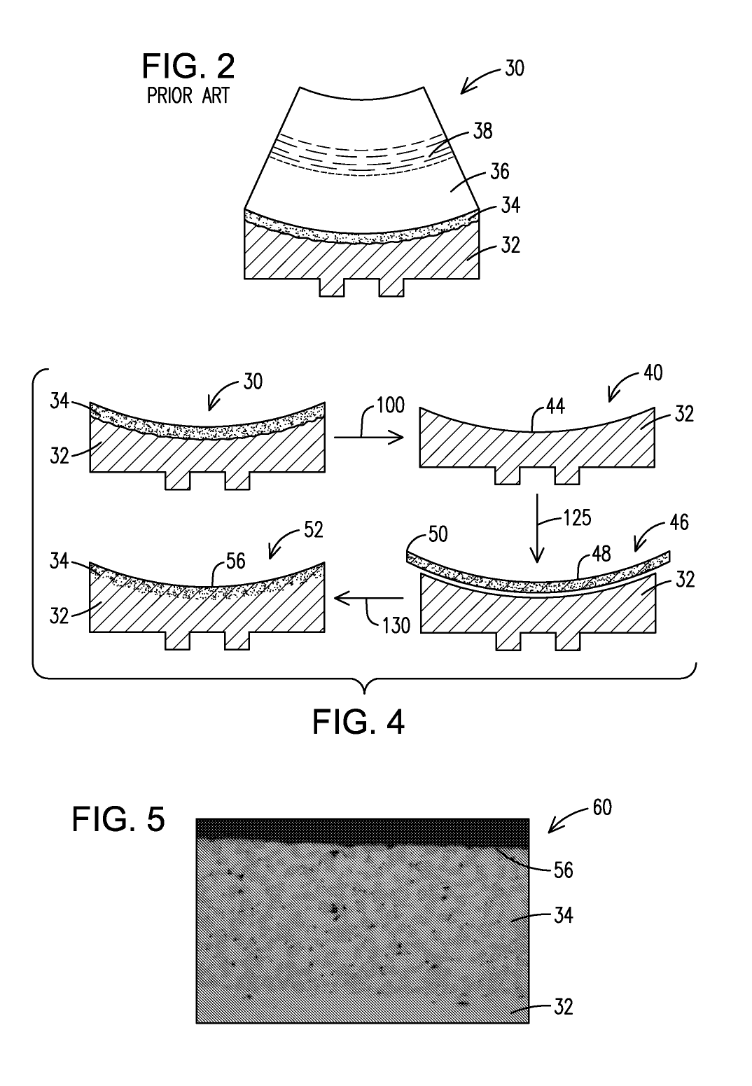

FIG. 4 illustrates one embodiment of a process for repairing a worn or damaged ring segment of a gas turbine engine. In this non-limiting example the worn ring segment 30 of FIG. 2 is subjected to some of the process steps illustrated in FIG. 3. Prior to the machining step 100, the worn ring segment 30 contains an abradable thermally-protective coating 34 which is bonded to a ring segment base 32. The protective coating 34 may contain a damaged abraded portion 38 (see FIG. 2). The machining step 100 completely removes the protective coating 34 to produce a machined ring segment base 40 in which the ring segment base 32 contains a coating-free machined repair surface 44. A PSP 48 is then disposed onto the coating-free machined surface 44 in step 125, and in the illustrated embodiment the PSP 48 slightly overhangs 50 the surface of the ring segment base 32 to form a pre-braze assembly 46. The brazing step 130 then causes the PSP 48 to undergo melting and bonding to the ring segment base 32 to form a repaired ring segment 52 containing a new abradable thermally-protective coating 34 having a repaired sealing surface 56. This repair process is accomplished without chemical stripping or welding as are required in the prior art process.

FIG. 5 illustrates a cross-sectional image 60 of one embodiment of a protective coating 34 and a portion of the ring segment base 32 formed by an embodiment of the present disclosure. The brazing process of this embodiment produces a protective coating 34 having a relatively low porosity (such as less than 4% by volume), a smooth sealing surface 56 having a low surface porosity (such as less than or equal to 10% by volume), and a low concentration of inclusions (such as having a maximum inclusion size of 100 μm).

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

1. A method comprising:
removing a damaged portion of a protective coating from a hot gas path surface of a service run ring seal segment of a gas turbine engine using a mechanical material removal process to reveal a repair surface;
applying a pre-sintered preform comprising a replacement protective coating material to the repair surface; and
heating the preform and ring segment together to braze the preform and to form a replacement protective coating on the repair surface upon cooling.

2. The method of claim 1, wherein the composition of the preform comprises:
Ni: 30-40 wt %;
Cr: 20-25 wt %;
Al: 2-10 wt %;
Si: 1-8 wt %;
W: 0.1-2.0 wt %;
Ta: 0.1-2.0 wt %;
B: 0.1-1.0 wt %;
Y: 0.1-1.0 wt %;
unavoidable impurities; and
Co.

3. The method of claim 1, wherein the preform comprises:
a first powder comprising:
Co: 54 wt %;
Cr: 23.5 wt %;
Ni: 10 wt %;
W: 7 wt %;
Ta: 3.5 wt %;
C: 0.6 wt %;
Zr: 0.5 wt %;
Ti: 0.2 wt %; and
unavoidable impurities,
based on a total weight of the first powder; and
a second powder comprising:
Co: 47 wt %;
Cr: 28.3 wt %;
Ni: 10 wt %;
W: 7 wt %;
Ta: 3.5 wt %;
C: 0.6 wt %;
Zr: 0.5 wt %;
Ti: 0.2 wt %;
B: 2.8 wt %; and
unavoidable impurities,
based on a total weight of the second powder.

4. A ring seal segment of a gas turbine engine repaired by the method of claim 1.

5. A method, comprising:
disposing a preform onto a component surface, such that a shape of the preform matches a shape of the component surface, to form a pre-braze assembly; and
heating the pre-braze assembly in order to melt the preform at a temperature less than a liquidus temperature of the component surface, to form a multi-layer component comprising a protective surface bonded to the component surface, wherein:
the preform is formed by sintering a powder mixture comprising
a first powder comprising a thermally-protective alloy adapted to protect the component surface in a hot gas path environment, and
a second power comprising a composition of the thermally-protective alloy that is supplemented with at least one additional element such that a solidus temperature of the second powder is lower than a solidus temperature of the first powder.

6. The method of claim 5, further comprising:
mechanically removing a portion of a damaged surface of a component to form a machined surface; and
cleaning the machined surface with a fluoride ion cleaning process to form the component surface.

7. The method of claim 6, wherein:
the component comprises a metallic base and a protective coating covering at least one surface of the metallic base;
the damaged surface of the component includes a portion of the protective coating; and
the mechanically removing step removes the portion of the protective coating and a portion of the metallic base.

8. The method of claim 5, wherein the component surface is prepared by performing a fluoride ion cleaning process prior to disposing the preform on that surface.

9. The method of claim 5, further comprising applying a ceramic coating to the protective surface to form a thermal barrier coating system.

10. The method of claim 5, wherein:
the thermally-protective alloy comprises Co, Ni, Cr, Al and Y; and
the additional element is Si, B, or a mixture thereof.

11. The method of claim 5, wherein the preform comprises:
Ni: 30-40 wt %;
Cr: 20-25 wt %;
Al: 2-10 wt %;
Si: 1-8 wt %;
W: 0.1-2.0 wt %;
Ta: 0.1-2.0 wt %;
B: 0.1-1.0 wt %;
Y: 0.1-1.0 wt %;
unavoidable impurities; and
Co,
based on a total weight of the powder mixture.

12. The method of claim 5, wherein the preform comprises:
Ni: 32.5 wt %;
Cr: 22.5 wt %;
Al 5.3 wt %;
Si 4.5 wt %;
W 0.65 wt %;
Ta: 0.3 wt %;
B: 0.3 wt %;
Y: 0.23 wt %;
unavoidable impurities; and
Co
based on a total weight of the powder mixture.

13. The method of claim 5, wherein:
a composition of the first powder comprises Co, Cr, Ni, W, Ta, C, Zr and Ti; and
a composition of the second powder comprises Co, Cr, Ni, W, Ta, C, Zr, Ti and B.

14. The method of claim 5, wherein:
a composition of the first powder comprises:
Co: 54 wt %;
Cr: 23.5 wt %;
Ni: 10 wt %;
W: 7 wt %;
Ta: 3.5 wt %;
C: 0.6 wt %;
Zr: 0.5 wt %;
Ti: 0.2 wt %; and
unavoidable impurities,
based on a total weight of the first powder; and
a composition of the second powder comprises:
Co: 47 wt %;
Cr: 28.3 wt %;
Ni: 10 wt %;
W: 7 wt %;
Ta: 3.5 wt %;
C: 0.6 wt %;
Zr: 0.5 wt %;
Ti: 0.2 wt %;
B: 2.8 wt %; and
unavoidable impurities,
based on a total weight of the second powder.

15. A multi-layer component formed by the method of claim 5.

16. A ring seal segment of a gas turbine engine repaired by the method of claim 5.

17. A method, comprising:
grinding a damaged surface of a component comprising a metallic base and a protective coating, such that the grinding removes at least a portion of the protective coating and a portion of the metallic base, to form a machined surface;
contacting a preform to the machined surface, such that the preform covers an entire area of the machined surface; and
brazing the preform onto the machined surface at a temperature less than a liquidus temperature of the metallic base, to form a multi-layer component comprising a protective surface bonded to the metallic base and covering at least the entire area of the machined surface,
wherein the protective surface has the same elemental composition as the preform; and
the method does not include a chemical stripping of the damaged surface to remove the protective coating.

18. The method of claim 17, further comprising cleaning the machined surface with a fluoride ion cleaning process before contacting the preform to the machined surface.

19. The method of claim 17, wherein the preform is formed by sintering a powder mixture comprising:
a first powder comprising a thermally-protective alloy adapted to protect the component surface; and
a second powder comprising a composition of the thermally-protective alloy that is supplemented with at least one additional element such that a solidus temperature of the second powder is lower than a solidus temperature of the first powder.

20. The method of claim 19, wherein:
a composition of the first powder comprises:
Co: 54 wt %;
Cr: 23.5 wt %;
Ni: 10 wt %;
W: 7 wt %;
Ta: 3.5 wt %;
C: 0.6 wt %;
Zr: 0.5 wt %;
Ti: 0.2 wt %; and
unavoidable impurities,
based on a total weight of the first powder; and
a composition of the second powder comprises:
Co: 47 wt %;
Cr: 28.3 wt %;
Ni: 10 wt %;
W: 7 wt %;
Ta: 3.5 wt %;
C: 0.6 wt %;
Zr: 0.5 wt %;
Ti: 0.2 wt %;
B: 2.8 wt %; and
unavoidable impurities,
based on a total weight of the second powder.
